(19) United States
(12) Patent Application Publication
(10) Pub. No.: US 2024/0274890 A1
(43) Pub. Date: Aug. 15, 2024

(54) ZINC MANGANESE-DIOXIDE ELECTROCHEMICAL BATTERY CELL

(71) Applicant: Jeffrey L. Arias, Downey, CA (US)

(72) Inventor: Jeffrey L. Arias, Downey, CA (US)

(73) Assignee: Zinc Electric Power, LLC, Wilmington, DE (US)

(21) Appl. No.: 18/441,978

(22) Filed: Feb. 14, 2024

Related U.S. Application Data
(60) Provisional application No. 63/576,504, filed on Feb. 14, 2023.

(51) Int. Cl. H01M 10/38; B82Y 30/00; H01M 4/02; H01M 4/04; H01M 4/505; H01M 4/62; H01M 4/66; H01M 10/42; H01M 50/463; H01M 50/489; H01M 50/509

(52) U.S. Cl. CPC H01M 10/38; B82Y 30/00; H01M 4/0445; H01M 4/505; H01M 4/625; H01M 4/667; H01M 10/42; H01M 50/463; H01M 50/489; H01M 50/509; H01M 2004/028; H01M 2010/4292; H01M 2300/0011

(57) ABSTRACT

The invention disclosed here is Zinc Manganese-Dioxide Electrochemical Battery Cell. The Zinc Manganese-Dioxide Electrochemical Battery Cell is comprised of at least one zinc foil anode coated with a polymer coating, at least one cathode comprised of a composite matrix of manganese dioxide and single-walled carbon nanotubes (“SWCNT”), and at least one separator, all contained within a sealed container filled with an aqueous electrolyte. There is always an equal number of anodes and cathodes. There is a separator between each adjacent anode and cathode. One cathode is fabricated upon a conductive substrate to which an electrical connection can be attached. Zinc Manganese-Dioxide Electrochemical Battery Cell uses a water-based electrolyte containing Zn sulfate and Mn sulfate additives. The cathode material of α-MnO2 nanofibers.

### CLAIM OF PRIORITY

This application claims priority to U.S. Provisional Utility Application No. 63/576,504 filed Feb. 14, 2023.

### FIELD OF INVENTION

The present invention relates to the technical area of electrochemical devices for obtaining and storing electrical energy. Specifically, the invention relates to rechargeable electrical storage batteries, and more particularly to secondary electrochemical cells with metallic zinc as the anode, an aqueous electrolyte, and a manganese dioxide cathode.

### BACKGROUND OF INVENTION

There is an increasingly urgent need to arrest the escalating damage of climate change by reducing the use of fossil fuels. There have been some successes to this end. For example, electric and hybrid electric vehicles have supplanted a significant number of internal combustion vehicles. The electrification of automotive transportation has been successfully accelerated by the performance improvements and cost reductions of the lithium-ion battery (“LIB”).

Further reduction in fossil fuel use is possible with electricity generated by solar and wind power, but these methods need energy storage in order to provide reliable power, be it for an individual home or for an entire electrical grid. Solar and wind power-generation are both now competitive with fossil fuels from a cost standpoint. However, the availability of solar- or wind-generated power is neither constant nor fully predictable. This necessitates energy storage in order to provide reliable power to the electrical grid when needed.

Although there are a variety of commercially-successful low-cost-energy-storage methods, most notably pumped hydro and underground compressed air, these are restricted in locations and limited in size by natural geography. The electrical storage battery has now emerged as the most promising and practical apparatus for wide-spread, large-scale grid-energy storage.

A battery is an electric power source consisting of one or more electrochemical cells with external connections for powering electrical devices. A rechargeable cell can be used to store electric power within a battery. The positive terminal is denominated the cathode and the negative terminal is denominated the anode. In keeping with electrical convention, electrons flow from the anode or negative terminal.

Among the storage-battery technologies now used for grid storage, LIB, lead-acid, sodium-ion, and flow batteries account for 98% of all current systems, dominated by LIB with 72%. Each of these technologies, however, suffer from one or more impediments to widespread implementation.

The most popular implementation of LIB technology uses lithium and cobalt as the main battery materials. Lithium has four major drawbacks. First, LIB technology has a significant intrinsic fire risk. The lithium-fire-hazard in grid storage has become widely recognized with approximately one fire per month documented in the past year, and constraints being placed on their siting due to safety concerns. Second, lithium mining and processing is toxic and damaging to the environment. Third, China is a major source of lithium, meaning that there are significant risks to supply-chain continuity. Fourth, LIB technology is high cost. Their significant cost raises the initial generation-cost for solar and wind.

Other current battery technologies have their own limitations. Lead-acid batteries used to be ubiquitous, and are the legacy battery technology in many applications, but are intrinsically toxic due to its high lead content. Lead-acid batteries also have a shorter life than newer technologies. Flow batteries such as Vanadium Redox require large storage tanks of reactive and toxic liquid electrolytes. Flow batteries have significant maintenance requirements which add to their operational cost. Last, flow batteries have such low energy-densities (Wh/L) that they need to be as much as 10λ larger than LIB technology to achieve the same energy storage. Aqueous sodium-ion batteries are safe and low in cost, but they are also about 7× larger than the best LIB technology.

While very large grid storage batteries built with these technologies are acceptable in remote rural locales, they are impractical in an urban setting where space is limited. The footprint for a large storage battery array using any of the existing technologies, other than LIB, would dwarf the available land in most urban electric sub-stations. Therefore, to accelerate the implementation of wind and solar power, a new battery technology is needed that simultaneously eliminates all of the impediments of current technologies. The market is looking for a storage technology that is safe, non-toxic, low-cost, compact, and long-lifed.

The present invention is a new aqueous battery based on zinc and manganese-dioxide (“ZMO”) chemistry, which is safe, non-toxic, low-cost, compact, and long-lifed. ZMO battery technology has been known since 1866, and is used today in the ubiquitous flashlight battery, which is safe and low cost, but not rechargeable. Rechargeability and long life with the ZMO chemistry requires simultaneously solving three problems: the formation of dendrites on the zinc anode which results in shorts, the evolution of hydrogen gas from the zinc anode which consumes electrolyte, and the cost of the cathode, which must be inexpensive and yet have high cycle-life, to be commercially viable for grid-storage applications.

There have been numerous research efforts to solve these problems individually, with demonstrated success, but a single ZMO battery cell that simultaneously solves all of these problems, while being sufficiently compact for urban installations, has yet to be realized. The practical volumetric energy density of the Zinc Manganese-Dioxide Electrochemical Battery Cell presented herein is 450 Wh/L, which is essentially equal to the energy density of the predominant LIB cell used for grid storage, a lithium-iron-phosphate (“LFP”) cell.

No such solution exists today.

### SUMMARY OF THE INVENTION

This summary is intended to disclose the present invention, a Zinc Manganese-Dioxide Electrochemical Battery Cell. The embodiments and descriptions of this application are used to illustrate the invention and its utility, and are not intended to limit the invention or its use.

The present invention, a Zinc Manganese-Dioxide Electrochemical Battery Cell, is re-chargeable, safe, low-cost, compact, long-lasting, and suitable for a grid storage battery cell. The Zinc Manganese-Dioxide Electrochemical Battery Cell is comprised of at least one zinc-foil anode coated with a polymer, at least one cathode comprised of a matrix composite of manganese dioxide and single-walled carbon nanotubes (“SWCNT”), and at least one separator, all contained within a sealed container filled with an aqueous electrolyte. One cathode is fabricated upon a conductive substrate. The anodes are always separated from the cathodes with a separator. There are the same number of anodes and cathodes.

The present invention, a Zinc Manganese-Dioxide Electrochemical Battery Cell, overcomes the limitations of prior ZMO batteries using four design elements: (1) a water-based electrolyte with Zn sulfate and Mn sulfate additives to provide conductivity and prevent zinc dendrite formation; (2) a polymer coating on the zinc-foil anode to suppress hydrogen evolution and produce uniform, even replating of the zinc during charging; (3) a cathode material of α-MnO2 nanofibers, which provides both high energy-density and high cycle-life; and (4) a thick cathode fabricated as a matrix of the above α-MnO2 nanofibers, together with SWCNT binder, so as to enable a cell with high energy-density. A battery constructed from one or more Zinc Manganese-Dioxide Electrochemical Battery Cells will have the following attributes: (A) intrinsically safe, having both a de minimis fire risk and no toxic materials; (B) low-cost as the result of bulk material pricing, (C) compact because it has a high volumetric energy density (Wh/L); and (D) long lasting, as measured by both the calendar and life-cycles.

ZMO battery technology is inherently safe, as it does not autoignite, is not easily ignitable, and is not constructed from toxic materials. As a result, the Zinc Manganese-Dioxide Electrochemical Battery Cells presented here are also inherently safe.

The Zinc Manganese-Dioxide Electrochemical Battery Cells will have a cost advantage compared to the current cells used for grid storage. To illustrate the cost advantage intrinsic in the Zinc Manganese-Dioxide Electrochemical Battery Cells compared to LFP technology, the cost of zinc per pound is about 1/40th the cost of lithium and the cost of manganese is about 1/20th the cost of the cobalt used in most of today's lithium batteries. The cost of materials is important because they typically comprise about ⅔ the total cost of a battery. In addition, the cost of manufacturing will be less because lithium battery production requires capturing fumes from toxic solvents and electrolyte, which are not present in the water-based Zinc Manganese-Dioxide Electrochemical Battery Cells described herein. Consequently, the cost of the Zinc Manganese-Dioxide Electrochemical Battery Cells is projected to be 20% to 30% less than the lowest cost LFP battery cells used for grid storage.

The Zinc Manganese-Dioxide Electrochemical Battery Cell has a long usable life as the result of the materials used. The α-MnO2 nanofiber cathode material has demonstrated 5,000 charge-discharge cycles with 92% capacity retention when used in cells with zinc-foil anodes and an aqueous electrolyte with a zinc-sulfate solution. Zinc-foil anodes with polymer coatings have demonstrated triple the cycle-life of uncoated zinc.

Cathodes with thicknesses up to 800 μm are possible using a matrix composite of manganese-dioxide and SWCNT. The resulting cell energy densities are double that of conventional-thickness electrodes.

The unique construction of the Zinc Manganese-Dioxide Electrochemical Battery Cell allows for a practical battery with surprisingly high energy-density that has long life, low cost, and is yet very compact so that it is uniquely suitable for urban applications. As an example, a grid storage battery constructed from Zinc Manganese-Dioxide Electrochemical Battery Cells would be ideal for peak-shaving electric-grid substations rated up to 32 MWH. The storage battery constructed from Zinc Manganese-Dioxide Electrochemical Battery Cells would be charged during times of low electricity-demand, and discharged during times of peak demand. The design details of an example cell and battery for this application, based on the present invention, are shown in Table 1. The resulting battery requires only a 634 sq. ft. footprint, which is approximately the same as the actual lithium-powered 32 MWH substation battery now operated by Southern California Edison in Tehachapi California. The example battery based on the present invention can fit into two standard 40-foot cargo containers, which will enable rapid, low-cost installations at existing limited-space urban sites like utility-grid substations or at EV-charging stations.

Although rechargeable Zinc Manganese-Dioxide grid batteries already exist, the present invention enables a major improvement over the current state-of-the-art commercial ZMO batteries. For comparison, the energy density of the an actual commercial ZMO battery is around 36 Wh/L, which would result in a footprint for a 32 MW grid-storage battery of almost 4,000 sq. ft., or almost 7× larger than the present invention.

In summary, the present invention, a Zinc Manganese-Dioxide Electrochemical Battery Cell, exhibits the attributes needed for an improved, more practical grid-storage battery cell: (A) It is safer than LFP because the water-based electrolyte is non-toxic and the materials are non-flammable; (B) It is low cost because the materials, zinc, manganese dioxide, and water are low-cost and abundant; (C) It is compact because of the thick cathode made possible with the SWCNT matrix creates a high volumetric energy density; and (D) It is long-life, capable of lasting thousands of cycles, because of the polymer coating on the zinc and the intrinsic long life of the α-MnO2 nanofibers

Whereas the improvements from each of these four disclosed design elements are individually desirable and can improve a specific attribute of a ZMO grid-storage battery, only the simultaneous combination of all four design elements enables a practical, safe, low cost, compact, and long life grid-storage battery that is superior to those currently used in the market.

TABLE 1
Theoretical Example of a Zinc Manganese-Dioxide
Electrochemical Battery Cell used for peak-shaving in an urban
substation.

| Characteristic | Metric | Notes |
|---|---|---|
| ANODE | | |
| Material | Zinc foil | From PNNL |
| Thickness | 100 μm | 1 side only |
| Theoretical capacity | 820 mAh/g | 100% utilization |
| % utilization efficiency | 50% | |
| Density | 7.13 g/cc | Zinc metal |
| Areal capacity | 20 mAh/cm² | |
| Polymer coating | Polyvinyl alcohol (PVA) | |
| Coating thickness | 10 μm | |
| Total electrode thickness | 110 μm | |
| CATHODE | | |
| Material | α-MnO₂ nanofibers | |
| Specific capacity | 285 mAh/g | |
| Material density | 5.4 g/cc | |
| Binder | 1% SWCNT | |
| Active material content | 50% | Assumed thickness |
| Composite capacity | 770 mAh/cc | |
| Thickness required | 260 μm | Up to 800 μm |
| | | possible |
| Substrate thickness | 50 μm | 1 side only |
| Total electrode thickness | 310 μm | 1 side only |
| CELL & \grave{ }BATTERY | | |
| Average discharge voltage | 1.3 | From PNNL |
| Separator thickness | 100 μm | |
| Total core thickness | 520 μm | Electrodes + |
| | | separator |
| Core energy density | 500 mWh/cc | Electrodes + |
| | | separator |
| Cell energy density | 450 Wh/L | 90% core packing |
| | | efficiency |
| Battery energy density | 225 Wh/L | Assume 50% cell |
| | | pack′g effic′y |
| 32 MWH footprint | 16′ X 40′ (634 sq. ft.) | Assume 8′ high |
| required | | building |

### BRIEF DESCRIPTION OF THE DRAWINGS

The present invention is illustrated with 3 figures on 3 sheets.

FIG. 1 is a diagram of a single Zinc Manganese-Dioxide Electrochemical cell.

FIG. 2 is a diagram of a parallel connection of two Zinc Manganese-Dioxide Electrochemical cells.

FIG. 3 is a series connection of three Zinc Manganese-Dioxide Electrochemical cells.

### DETAILED DESCRIPTION OF THE DRAWINGS

The following descriptions are not meant to limit the invention, but rather to add to the summary of invention, and illustrate the present invention, by offering and illustrating various embodiments of the present invention, a Zinc Manganese-Dioxide Electrochemical Battery Cell 11, 12, 13. While embodiments of the invention are illustrated and described, the embodiments herein do not represent all possible forms of the invention. Rather, the descriptions, illustrations, and embodiments are intended to teach and inform one skilled in the art without limiting the scope of the invention.

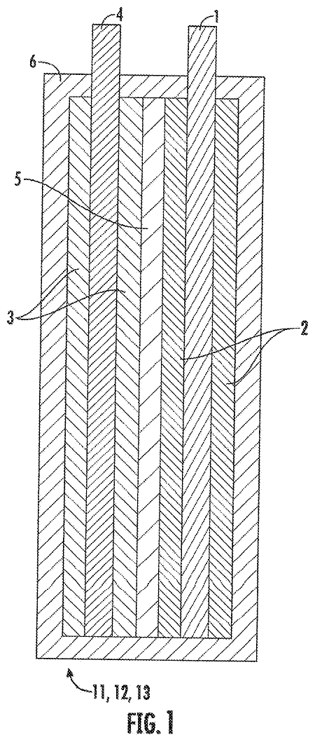

FIGS. 1-3 shows a simplified diagram of the present invention, a Zinc Manganese-Dioxide Electrochemical Battery Cell 11, 12, 13. The Zinc Manganese-Dioxide Electrochemical Battery Cell 11, 12, 13 is intended for use in applications such as grid-storage batteries. The Zinc Manganese-Dioxide Electrochemical Battery Cell 11, 12, 13 is comprised of at least one zinc foil anode 1 coated with a polymer coating 2, at least one cathode 3 consisting of a composite matrix of manganese dioxide and SWCNT, and at least one separator 5, all contained within a sealed container 6 filled with an aqueous electrolyte. There is always an equal number of anodes 1 and cathodes 3. There is a separator 5 between each adjacent anode 1 and cathode 3. One cathode 3 is fabricated upon a conductive substrate 4.

The aqueous electrolyte is comprised of water, 2-molar zinc-sulfate, and 0.1-molar manganese-sulfate. The aqueous electrolyte provides conductivity and prevents zinc dendrite formation. The electrolyte as comprised is slightly acidic.

The maximum potential volumetric energy density of the Zinc Manganese-Dioxide Electrochemical Battery Cell 11, 12, 13 presented herein is 550 Wh/L. As shown in the summary, a useful Zinc Manganese-Dioxide Electrochemical Battery Cell 11, 12, 13 in Table 1 would have a volumetric energy density of 450 Wh/L. This invention 11, 12, 13 lends itself to cells 11, 12, 13 with volumetric energy densities of at least 100 Wh/L. Such a cell 11, 12, 13 would have a usable life that surpassed 1,000 cycles.

The polymer coating 2 on each of the at least one zinc-foil anodes 1 suppresses hydrogen evolution and produces uniform and even replating of the zinc during charging. The polymer coating 2 is one of the following: polyvinyl alcohol; polyethylene oxide; benzyltrimethyl ammonium (“TMBA+”); poly (trimethylsilyl) propyne (PTMSP); and β-phase poly vinylidene difluoride (β-PVDF). The polymer coating 2 is deposited using one of the following techniques known in the art: doctor blade, dip coating, physical vapor deposition, chemical vapor deposition, electrodeposition, or spraying. When using polyethylene oxide as the polymer coating 2, electrodeposition of the polymer material onto the zinc foil occurs from an additive previously included in the electrolyte during re-charging. The polymer coating 2 has an overall thickness between one micron to 50 μm. Preferably, the polymer coating 2 is between 7 and 17 μm.

The manganese-dioxide in the at least one cathode 3 is α-MnO2 nanofibers. In the currently preferred embodiment, the at least one cathode 3 is comprised of α-MnO2 nanofibers in a composite matrix with SWCNT binder. The α-MnO2 nanofibers are typically from 10 to 150 nm in diameter and 65 to 500 nm in length, although the actual length of such nanofibers is dependent on the overall shape of the crystalline structure that forms the nanofiber. No claim is made as to the diameter and length of the α-MnO2 nanofibers used in the present invention, as the nanofiber size has not been shown to differentiate performance. Using α-MnO2 nanofibers in the at least one cathode 3 provides both high energy-density and high cycle-life. The SWCNT are 5 to 50 nm in diameter and between 50 μm and 100 μm in length. The at least one composite matrix cathode 3 is between 100 μm and 800 μm thick with an areal capacity of at least 5 mAh/cm2, when discharged at the 4-hour rate. In the current preferred embodiment, the at least one composite matrix cathode 3 has a thickness of between 200-300 μm and an areal capacity of between 10-20 mAh/cm. The at least one composite matrix cathode 3 can also contain one or more of the following conductive additives: multi-walled carbon nanotubes, carbon flakes, carbon nanofibers, or carbon particles.

One composite matrix cathodes 3 is fabricated upon a conductive substrate 4. The conductive substrate 4 must be compatible with the electrolyte. The conductive substrate 4 must have a conductivity of at least 1×10⁴ S/cm. The conductive substrate 4 should be less than 100 μm thick. Functionally, the conductive substrate 4 material must allow for an electrical connection to be made.

The at least one separator 5 is porous and non-conductive. The at least one separator 5 should be non-reactive to prolonged exposure to the electrolyte at temperatures of 120° F. The at least one separator 5 is less than 200 μm thick. In the currently preferred embodiment, the at least one separator 5 is less than 50 μm thick.

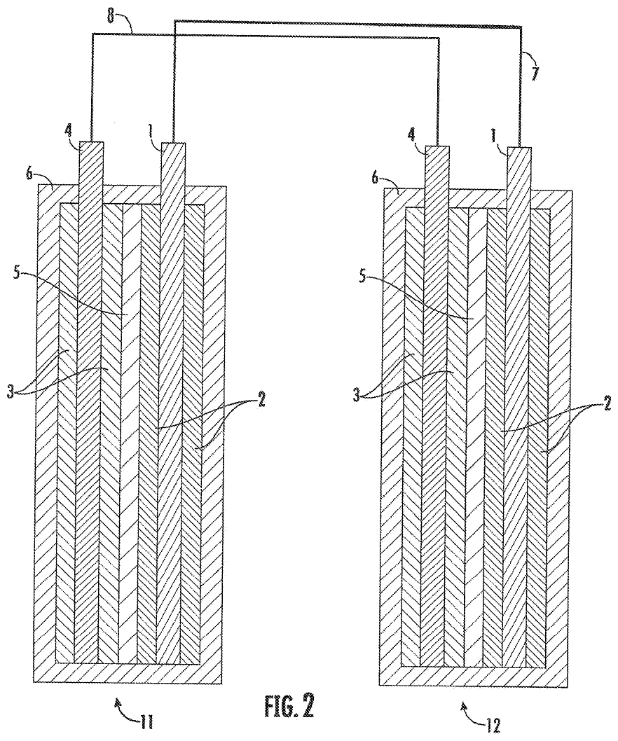

FIG. 2 shows two Zinc Manganese-Dioxide Electrochemical Battery Cells 11, 12 arranged with an electrically parallel connection. Each Zinc Manganese-Dioxide Electrochemical Battery Cell 11, 12 is comprised of at least one zinc-foil anode 1 coated with a polymer coating 2, at least one cathode 3 consisting of a composite matrix of manganese dioxide and SWCNT upon a conductive substrate 4, and at least one separator 5, all contained within a sealed container 6 filled with an aqueous electrolyte. A conductive substrate 4 of the first Zinc Manganese-Dioxide Electrochemical Battery Cell 11 is electrically connected 8 to a conductive substrate 4 of the second Zinc Manganese-Dioxide Electrochemical Battery Cells 12. An anode 1 of the first Zinc Manganese-Dioxide Electrochemical Battery Cell 11 is electrically connected 7 to an anode 1 of the second Zinc Manganese-Dioxide Electrochemical Battery Cells 12. When connected in parallel, the voltage as measured between either of the conductive substrates 4 connected by 8 and either of the anodes 1 connected by 7 is identical for each Zinc Manganese-Dioxide Electrochemical Battery Cell 11, 12.

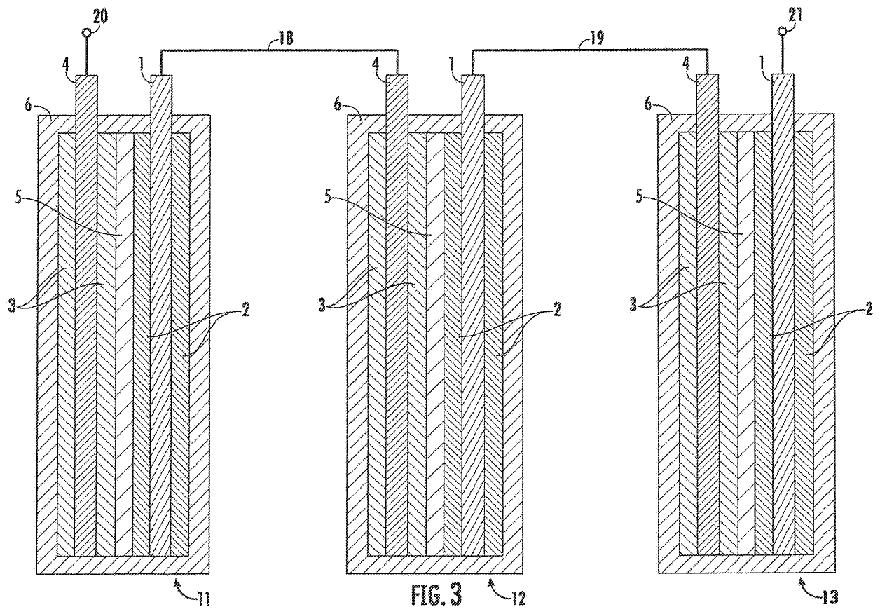

FIG. 3 shows three Zinc Manganese-Dioxide Electrochemical Battery Cell 11, 12, 13 arranged with series connections. Each Zinc Manganese-Dioxide Electrochemical Battery Cell 11, 12, 13 is comprised of at least one zinc-foil anode 1 coated with a polymer coating 2, at least one cathode 3 consisting of a composite matrix of manganese dioxide and SWCNT upon a conductive substrate 4, and at least one separator 5, all contained within a sealed container 6 filled with an aqueous electrolyte. A conductive substrate 4 of the first Zinc Manganese-Dioxide Electrochemical Battery Cell 11 is connected to an output terminal 20. An anode 1 of the first Zinc Manganese-Dioxide Electrochemical Battery Cell 11 is electrically connected 18 to a conductive substrate 4 of the second Zinc Manganese-Dioxide Electrochemical Battery Cells 12. An anode 1 of the second Zinc Manganese-Dioxide Electrochemical Battery Cell 12 is electrically connected 19 to a conductive substrate 4 of the third Zinc Manganese-Dioxide Electrochemical Battery Cells 13. An anode 1 of the third Zinc Manganese-Dioxide Electrochemical Battery Cells 13 is connected to an output terminal 21. The voltage between the two terminals 20, 21 is the sum of the voltage drop between the anode 1 and conductive substrate 4 of each of the Zinc Manganese-Dioxide Electrochemical Battery Cells 11, 12, 13, if the electrical connections 18, 19 between the Cells 11, 12, 13 is broken.

Two or more Zinc Manganese-Dioxide Electrochemical Battery Cells (e.g., 11, 12, 13) can be connected in series and parallel to create a multi-cell battery with a desired pre-determined voltage. Multiple alternating layers of anode 1, separator 5, and cathode 3 can be housed in a single sealed container 6, allowing for design flexibility when creating a battery for a specific application. Individual battery cells are most commonly packaged in industrial batteries as prismatic stacks, spiral wraps, or bipolar-plate-stacks. Anodes, cathodes and separators of individual Zinc Manganese-Dioxide Electrochemical Battery Cells (e.g., 11, 12, 13 are most commonly packaged in widely known configurations such as prismatic stacks, spiral wraps, and bipolar-plate-stacks.

I claim:

1. A rechargeable, electrical-storage battery cell comprised of:
at least one zinc-foil metal anode coated with a polymer coating;
at least one cathode comprised of a composite matrix of manganese dioxide and single-walled carbon nanotubes (“SWCNT”);
at least one separator;
a sealed container with an aqueous electrolyte;
wherein there are an equal number of anodes and cathodes;
wherein one cathode is fabricated upon a conductive substrate;
wherein a separator is interposed between adjacent anodes and cathodes; and
wherein the battery cell has a volumetric energy density of at least 100 Wh/L, and a life of at least 1000 cycles.

2. The rechargeable, electrical-storage battery cell of claim 1, wherein the aqueous electrolyte is comprised of water, 2-molar zinc-sulfate, and 0.1-molar manganese-sulfate.

3. The rechargeable, electrical-storage battery cell of claim 2, wherein the polymer coating is at least one of polyvinyl alcohol; polyethylene oxide; benzyltrimethyl ammonium (“TMBA+”); poly (trimethylsilyl) propyne (PTMSP); and β-phase poly vinylidene difluoride (β-PVDF).

4. The rechargeable, electrical-storage battery cell of claim 3, wherein the polymer coating has a thickness between 1 and 50 μm.

5. The rechargeable, electrical-storage battery cell of claim 4, wherein the manganese dioxide of the at least one cathode is alpha-manganese-dioxide (“α-MnO2”) nanofibers.

6. The rechargeable, electrical-storage battery cell of claim 5, wherein the SWCNT of the at least one cathode have a diameter between 5 to 50 nm and a length between 50 and 100 μm.

7. The rechargeable, electrical-storage battery cell of claim 6, wherein the at least one cathode is at least 100 μm thick with an areal capacity of at least 5 mAh/cm2, when discharged at a 4-hour rate.

8. The rechargeable, electrical-storage battery cell of claim 7, wherein the conductive substrate is less than 100 μm thick, has a conductivity of at least 1×10⁻⁴ S/cm, and is non-reactive with the electrolyte.

9. The rechargeable, electrical-storage battery cell of claim 8, wherein an electrical connection can be made to the conductive substrate.

10. The rechargeable, electrical-storage battery cell of claim 9, wherein the at least one separator is porous, non-conductive, and non-reactive to prolonged exposure to the electrolyte at temperatures of up to 120° F.

11. The rechargeable, electrical-storage battery cell of claim 10, wherein the at least one separator is less than 200 μm thick.

12. The rechargeable, electrical-storage battery cell of claim 11, wherein the at least one separator is less than 50 μm thick.

13. The rechargeable, electrical-storage battery cell of claim 11, wherein the polymer coatings are deposited using at least one of doctor blade, dip coating, physical vapor deposition, chemical vapor deposition, electrodeposition, and spraying.

14. The rechargeable, electrical-storage battery cell of claim 13, wherein the polymer coating has a thickness between 7 and 17 μm.

15. The rechargeable, electrical-storage battery cell of claim 14, wherein the polymer coating is polyethylene oxide.

16. The rechargeable, electrical-storage battery cell of claim 15, wherein electrodeposition of the polymer material onto the zinc foil occurs during re-charging due to an additive previously included in the electrolyte.

17. The rechargeable, electrical-storage battery cell of claim 11, wherein the cathode is further comprised of at least one of following conductive additives: multi-walled carbon nanotubes, carbon flakes, carbon nanofibers, or carbon particles.

18. The rechargeable, electrical-storage battery cell of claim 11, wherein the cathode is between 200 to 300 μm thick and has an areal capacity of 10-20 mAh/cm2.

19. The rechargeable, electrical-storage battery cell of claim 11, wherein the battery cell is configured within the sealed container as one of a prismatic stack, a spiral wrap, and a bipolar-plate-stack.

20. The rechargeable, electrical-storage battery cell of claim 19, wherein a series configuration is comprised of the battery cell connected electrically in series with at least one other identical battery cell.

21. The rechargeable, electrical-storage battery cell of claim 20, wherein at least two series configurations can be connected electrically in parallel.

22. The rechargeable, electrical-storage battery cell of claim 19, wherein a parallel configuration is comprised of the battery cell connected electrically in parallel with at least one other identical battery cell.

23. The rechargeable, electrical-storage battery cell of claim 22, wherein at least two parallel configurations can be connected electrically in series.
